(19) United States
(12) Patent Application Publication
(10) Pub. No.: US 2012/0226528 A1
(43) Pub. Date: Sep. 6, 2012

(54) Result-based Payment Method and System

(76) Inventor: Roswitha Warda, Sebastopol, CA (US)

(21) Appl. No.: 13/040,151

(22) Filed: Mar. 3, 2011

(51) Int. Cl. G06Q 10/00; G06Q 20/00

(52) U.S. Cl. 705/7.38

(57) ABSTRACT

The invention is a method and system for providing compensation for services based on the results achieved using these services.

Users or their sponsors deposit value to obtain a certain amount of credits and are then granted free access to the service. The system identifies areas the user is struggling with, and provides a personalized practice cycle. Progress is monitored and tracked. User behavior influences customized intervention until the desired and pre-defined result has been achieved. This outcome or result is measured via pre-defined indicators. Once a result has been achieved, the task is removed from the practice cycle, the result is registered, and a learning credit is deducted from the deposit as compensation.

### FIELD OF THE INVENTION

The present invention relates to a compensation system and, more particularly, to a method for calculating payment owed based on measured results obtained during a process. This process has its most obvious application where formerly intangible results are the goal, as in education, coaching, self-improvement, sports, etc.

### BACKGROUND OF THE INVENTION

Ever since intangible services, such as education, coaching, self-improvement, etc., have been offered, their compensation has been based on fixed rates, and subject for debate. This contrasts with consumer experience when obtaining tangible goods, where compensation is commonly tied to a clearly measured “result,” for example a certain size, quality or quantity of the item purchased.

In education and similar areas the “product” (knowledge or an improved skill) is intangible and has in the past evaded such measured and result-based compensation models. Success and results used to be assessed with an unfair amount of vagueness and never in direct correlation to the services that have been utilized to reach those goals.

Prior to the data processing aptitude of digital technology it was hard or impossible to track the results a user obtained from a certain educational process, material, or procedure.

It was simply not feasible to determine which elements of knowledge the learner possessed prior to using the service, and to track long-term learning gain in a way that would clearly document knowledge acquisition facilitated by the program:

Traditionally, intangible services like educational programs, tutoring, coaching, or self-improvement programs are compensated by requesting
payment for time enrolled (subscription/membership/stipend),
payment for the number of units studied,
payment to participate in or to pass a test,
payment for the resources provided (classes, tutoring),
purchase of learning resources (textbooks, software, etc.).

Traditional education models often follow a “one-size-fits-all” approach and are limited in their ability to provide personalized instruction that adapts to the student's level of knowledge and goals.

Even where a certain amount of personalization is provided, it is commonly not designed to provide such personalized intervention until performance data can prove that the learning gap has been closed, reliably and in the long-term. Thus even personalized programs do not automatically provide a reliable indication of permanent knowledge.

Traditional systems put an unfair burden on the student and those paying for the learner's educational progress (parents, school system, etc.). Payment is expected regardless of the quality of instruction provided, and regardless of how much learning has been gained. A student may join a course knowing everything that is being taught, yet has to pay the same amount as someone who is able to extract a lot of value from the same course due to a higher level of learning gaps.

Furthermore, when education is billed via a time unit, such as through a subscription, membership, or class fee, etc., students may not be able to obtain the full benefit they paid for due to changing schedules, shift in priorities, or deteriorating valuation of the service provided etc. Again, the student in this scenario ends up paying for services they did not benefit from.

Finally, since tests evaluate existing knowledge as well as newly gained one, administrators often struggle to understand what kind of learning gain resulted from a certain learning strategy or program. To date, very few programs even measure performance and results. The programs that do often don't provide initial and final assessments and don't track the immediate learning gains. Even the programs that do track progress do so by looking at the test results. They do not provide an integrated assessment of the intervention steps that were offered and completed to achieve these results. They are therefore unable to assess the direct learning gain and measure how the program facilitated and supported the learning progress.

All educational programs so far have left the responsibility for ensuring a successful investment to the guesswork of administrators, parents, and students. Performance reporting is spotty and unrelated to how the program is paid for, leaving the learner guessing what their knowledge return on their investment is.

It is therefore an object of the invention to

(a) provide a fair and result-based payment method based on measured results,
(b) assess and document units in need of further review/practice,
(c) manage the predefined practice cycle for units in need of remediation,
(d) track and document progress,
(e) provide a payment system that allows users to purchase learning credits for use in the system,
(f) provide unlimited free access to the service,
(g) deduct a unit of learning credits when the predefined result is achieved and documented.

### Clarifying Note

The invention provides the consumer with the benefit of only paying for measured results. Tracking and applying credit to such learning or coaching results is a task economically feasible only since the advent of computer technology. The solution described in this patent could theoretically be applied manually or without the use of computer databases. However, such an application is unlikely, due to the prolonged and detailed data tracking and processing required. The most common application of this system will therefore be in computer-assisted environments, and best administrated in a system that directly connects the user to the provider, such as through the Internet.

### BRIEF DESCRIPTION OF THE DRAWING FIGURES

A complete understanding of the present invention may be obtained by reference to the accompanying drawing, when considered in conjunction with the subsequent, detailed description, in which:

FIG. 1 is a plan view presenting the logic and action flow of the new payment system.

Reference Numerals in Drawings

| | | | |
|---|---|---|---|
| 1 | User | 2 | Assessment |
| 3 | Performance-based | 4 | List of known items |
| | sorting mechanism | | |
| 5 | Practice list | 6 | Personalized Instruction |
| 7 | First review | 8 | Review-based sorting mechanism 1 |
| 9 | Second review | 10 | Review-based sorting mechanism 2 |
| 11 | Third review | 12 | Review-based sorting mechanism 3 |
| 13 | Third party results | 14 | Result processor |
| 15 | Credit processor | 16 | Reporting module |
| 17 | Sponsor | 18 | User's deposit |
| 19 | Sponsor's deposit | 20 | User credits |
| 21 | Sponsor credits | 22 | non-payment credit assignment |
| 23 | direct retrospect payment | | |
| | charge | | |

### DESCRIPTION OF THE PREFERRED EMBODIMENT

The system consists of two areas: The payment processing/credit deposit area and the practice cycle. These two areas interact at the moment at which a result is registered, and a credit deducted from the user credits (19). The actual learning process and resources do not incur a charge. Before the user (1) is admitted to the practice cycle, the user's account either has to show user credits (19), sponsor credits (21), or similar value or means to cover the charge due when a result registers.

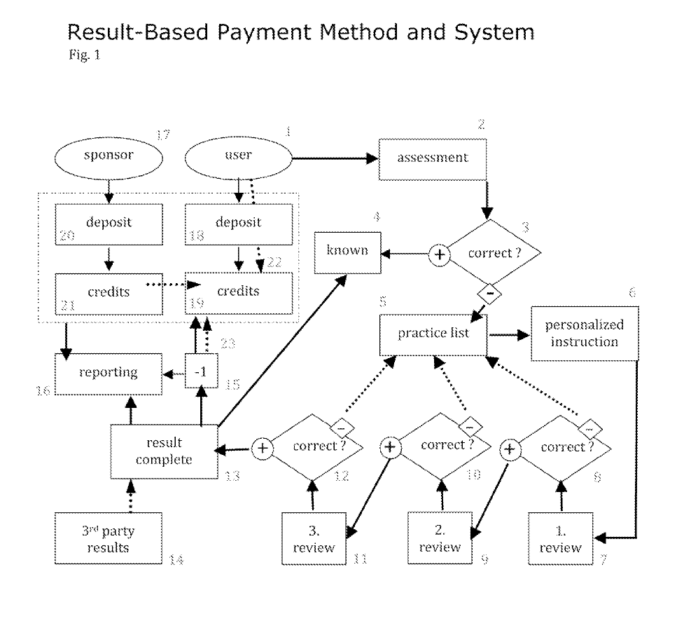

Typically, a user (1) will purchase credits through a traditional payment portal, wherein the user's deposit (18) creates a credit deposit, increasing the number of user credits (19). It is also conceivable that the user (1) is provided with an option to add to the user credits (19) in other, non-monetary ways, for example by bartering, “earning points” through certain activities, etc. This non-payment credit assignment (22) is represented by the dotted line connecting the user (1) directly to the user credits (19). It is further an option, and in congruence with this method, that a user (1) may have the option to pay for learning credits directly, without first adding these credits to a user's deposit (18). This could be facilitated, for example, by storing payment information and a pre-authorization and charging the amount owed directly at the end of each session. This direct retrospect payment charge (23) is indicated in FIG. 1 by the dotted line going from the user (1) directly to the credit processor (15).

The system further allows for third party entities acting as optional sponsors. This allows institutions like schools or universities to sponsor (17) their students' studies through one deposit, or parents, for example, to pay for multiple children through one account. The sponsor's deposit (20) provides the sponsor (17) with credits in their sponsor credits (21) account. By assuming sponsorship for a particular user (1), the sponsor credits (21) pay for the student's results, and the user credits (19) are not reduced.

Any activity in the payment processing/credit deposit area is apparent in the reporting module (16), so that both users and sponsors have the ability to understand who paid for learning results, the cost of credit acquisition, and the current level of either the sponsor credits (21) or user credits (19), in addition to data relating to the learning process itself.

At the start of the practice cycle, the system takes a few preliminary steps that have been omitted from the drawing in order to prevent it from growing too cluttered, since they can be considered obvious. For one, since the system is based on personalization, the user (1) is logged into their personal account. All data is managed through database table entries correlated to that unique user (1).

The system will also commonly check that payment for results is available through the aforementioned payment/deposit structure.

The user 1 is then exposed to an assessment (2) based on their learning goal with the objective to determine which items are known, and can be added to the list of known items (4), and which need to be added to the practice list (5).

The drawing focuses on the process used to determine that a result has been achieved. It should be understood that the assessment (2) element is commonly used to continuously feed new knowledge into the practice cycle for ongoing assessment (2) and progress.

Once an item has passed assessment (2) successfully, it is added to the list of known items (4) and will not be shown again. If the user (1) is struggling with a particular item, it is added to the practice list (5) and enters the practice cycle. Learning sessions are designed to provide personalized instruction (6), so that each session is custom designed by considering the practice requirements and goals of the user (1), plus previous learning data processed by the performance-based sorting mechanism (3).

The practice cycle may consist of any number of review points, as has been determined to be appropriate in order to achieve long-term acquisition of the skill by the system designer and/or underlying science. Current neuro-scientific research emphasizes the need for practicing new knowledge in spaced intervals, and while the number of repetitions recommended varies, in our initial implementation we determined that three successful reviews in consecutive order represented a high likeliness that the item has been learned successfully. Different circumstances may require a different number of reviews to guarantee success, and the invention only requires that a predetermined set of reviews is passed in consecutive order.

Other options may be added, such as timing the repetitions in certain intervals, delaying a repetition if learning sessions are launched within too short a time sequence, extending the interval timing as the learner demonstrates increased confidence, etc.

Special emphasis should be given at this point to the fact that a program that requires three successful reviews in consecutive order may in fact require many more reviews, since each error interspersed will reset the count to zero.

Once an item has been added to the practice list (5), it is submitted for its first review (7) in the next session. Review-based sorting mechanism 1 (8) compares the answer given to the correct answer required. If the answer was given correctly, the word is moved on to its second review (9) and the initial successful review is tracked in the database. If the user (1) fails to submit the right response, the item's score is reset and the practice cycle starts over at the next session.

After the second review (9), the answer is assessed by review-based sorting mechanism 2 (10), and if correct again, submitted to the third review (11) and processed by review-based sorting mechanism 3 (12).

If it reaches the final review point and the user (1) again succeeds in accomplishing the required task, then the item is passed on to the result processor (13). The result processor (13) registers the result, removes the item from the practice cycle, adds it to the list of known items (4), deducts a learning credit from the user (1), and adds the result to the reporting data.

The system provider by deducting the agreed on unit of learning credits receives payment for the service provided.

The result processor (13) may also optionally be enabled to include third party results (14) in this process. It would in this case look for documented results passed into the system by third party programs, which then cause a credit deduction just like a result created by the practice cycle would.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method and system to transfer payment between a user and a provider in a transaction based on measured results achieved, the method comprising means:
for assessing user knowledge;
for designing the program's intervention based on the assessment;
for guiding the user through a clearly defined review process customized to reflect user input;
for tracking performance to determine when the predefined objective has been achieved;
for deducting from the user's deposit the defined number of credits once the desired result has been accomplished;
whereby a measured, fair, and result-based mode of compensation is provided.

2. The result based payment method and system as recited in claim 1, further comprising:
a means for adding learning items where performance fell short of the requirements to a practice list.

3. The result based payment method and system as recited in claim 1, further comprising:
an optional means for adding learning result data as documented by a third party (transfer of assessment or performance data from another provider).

4. The result based payment method and system as recited in claim 1, further comprising:
a means for receiving a monetary deposit from the user, wherein said deposit makes available a number of credits to be used as currency units in the system.

5. The result based payment method and system as recited in claim 1, further comprising:
an alternative means for paying directly for the learning credit deducted instead of prepaying a deposit.

6. The result based payment method and system as recited in claim 1, further comprising:
an alternative means for making available a number of credits to be used as currency units in the system without monetary payment being a requirement to obtain such credits, for example by paying via non-monetary means (bartering, bonuses, reward points, etc.).

7. The result based payment method and system as recited in claim 1, further comprising:
an alternative means for supplementing the result-based payment method with traditional payment methods or offering it as on optional choice.

8. The result based payment method and system as recited in claim 1, further comprising:
a means for offering a sponsorship method and system that allows organizations to act as sponsors of other users or organizations using credits from their own deposit.

9. The result based payment method and system as recited in claim 1, further comprising:
a means for offering a sponsorship method and system that allows individuals to act as sponsors of other users or organizations using credits from their own deposit.

10. The result based payment method and system as recited in claim 1, further comprising:
a means for providing a reporting system that allows user to review performance and credit usage overall or for a specific time frame.

11. The result based payment method and system as recited in claim 1, further comprising:
a means for providing a reporting system that allows user to retrieve data for each result.

12. The result based payment method and system as recited in claim 1, further comprising:
a means for providing a reporting system that displays who paid for a certain credit.

13. The result based payment method and system as recited in claim 1, further comprising:
a means for providing an accounting system for credit purchases and credit levels.
